(19) United States
(12) Patent Application Publication
(10) Pub. No.: US 2025/0300680 A1
(43) Pub. Date: Sep. 25, 2025

(54) SIGNAL GENERATOR SYSTEM

(71) Applicant: Rohde & Schwarz GmbH & Co. KG, Muenchen (DE)

(72) Inventor: Simon SCHMID, Muenchen (DE)

(21) Appl. No.: 18/610,688

(22) Filed: Mar. 20, 2024

(51) Int. Cl. H04B 1/04; H04B 1/00

(52) U.S. Cl. CPC H04B 1/04; H04B 1/0096

(57) ABSTRACT

Embodiments of the present disclosure relate to a signal generator system for generating a high frequency output signal. The signal generator system includes a base device and a frequency extension device. The base device has a radio frequency output port via which a radio frequency signal is outputted. The frequency extension device includes exactly one radio frequency input port. The frequency extension device includes at least one high frequency output port, a low frequency path and at least one high frequency path. The frequency extension device has a signal distribution circuit. The frequency extension device includes a switch located in the low frequency path. The frequency extension device includes a combining circuit connected with the low frequency path, the at least one high frequency path and the at least one high frequency output port of the frequency extension device.

### FIELD OF THE DISCLOSURE

Embodiments of the present disclosure relate to a signal generator system for generating a high frequency output signal.

### BACKGROUND

In the state of the art, signal generator systems are known that are used to generate a certain radio frequency signal having a dedicated frequency range. The respective radio frequency signals typically comprise frequencies in the high frequency (HF) range.

Signal generator systems are known that comprise two separately formed devices, namely a base device as well as a frequency extension device, which are connected with each other. The base device provides a radio frequency signal that is processed by the frequency extension device in order to generate the high frequency output signal.

In the state of the art, two solutions are known which however have drawbacks with regard to the frequency range of the high frequency output signal or require additional hardware and connections, thereby making the overall signal generator system more cost-intensive.

According to a first solution known in the state of the art, a single radio frequency line connects the base device with the frequency extension device. The frequency extension device comprises a frequency multiplier and an amplifier for multiplying the frequency and amplifying the amplitude of the radio frequency signal. This solution however results in a limited frequency range for the high frequency output signal, as the frequency range of the base device cannot be covered anymore by the frequency extension device.

According to a second solution known in the state of the art, which shall overcome the drawbacks mentioned above, the base device is connected with the frequency extension device by two separate radio frequency lines. Hence, the frequency extension device comprises two or more radio frequency input ports for receiving the two different radio frequency signals from the base device that has two or more output ports. This however makes the overall signal generator system more complex and cost-intensive, as two separate radio frequency lines have to be connected. Additionally, the spectral purity is reduced since the frequency extension device processes two separate radio frequency signals simultaneously, which are combined afterwards.

Accordingly, there is a need for a signal generator system that can be provided in a cost-efficient manner while simultaneously ensuring a high frequency range and/or an excellent spectral purity for the high frequency output signal generated.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a signal generator system for generating a high frequency output signal. In an embodiment, the signal generator system comprises a base device and a frequency extension device. The base device comprises a radio frequency output port via which a radio frequency signal is outputted. In an embodiment, the base device has only one radio frequency output port, namely exactly one radio frequency output port or just a single radio frequency output port.

The frequency extension device comprises exactly one radio frequency input port that is connected with the radio frequency output port of the base device. Accordingly, the frequency extension device has only one radio frequency input port for receiving the radio frequency signal from the base device, namely a single radio frequency input port.

In an embodiment, the frequency extension device also comprises at least one high frequency output port via which the high frequency output signal generated can be outputted.

In an embodiment, the frequency extension device further comprises a low frequency path and at least one high frequency path. The at least one high frequency path may process radio frequency signals with a frequency being ten times higher than the frequency of the radio frequency signal processed by the low frequency path, e.g. N*(f1 to f2) for the at least one high frequency path and (f1 to f2) for the low frequency path.

In an embodiment, the frequency extension device also comprises a signal distribution circuit that is connected to the radio frequency input port of the radio frequency extension device, the low frequency path and the at least one high frequency path. The radio frequency signal received via the radio frequency input port can be distributed to the low frequency path and/or the at least one high frequency path due to the signal distribution circuit, for example based on a certain setting of the signal distribution circuit.

In an embodiment, the frequency extension device further comprises a switch located in the low frequency path. The switch can be used for changing the status of the low frequency path, e.g. switching on the low frequency path or switching off the low frequency path. In other words, the switch is configured to suppress any contribution of the radio frequency signal processed by the low frequency path.

In an embodiment, the frequency extension device further comprises a combining circuit connected with a low frequency path, the at least one high frequency path and the at least one high frequency output port of the frequency extension device. The combining circuit is enabled to combine the signals received via the low frequency path and the at least one high frequency path so as to forward the signals to the at least one high frequency output port.

The main idea is to provide the frequency extension device having two separate frequency paths that are associated with only one single radio frequency input port via which the frequency extension device is connected with the base device. In other words, the radio frequency signal received from the base device is internally processed by the frequency extension device, for example the signal distribution circuit and the combining circuit as well as the low frequency path and the high frequency path, such that the high frequency output signal is generated and outputted at the high frequency output port of the frequency extension device. The frequency extension device ensures that an excellent spectral purity and a large frequency range for the high frequency output signal can be obtained easily and at low costs. Specifically, this is ensured by the two paths that are connected to the single radio frequency input port, wherein the low frequency path comprises the switch such that any contribution of the radio frequency signal processed by the low frequency path to the high frequency output signal outputted can be suppressed.

Depending on the setting of the signal distribution circuit, the radio frequency signal received via the single radio frequency input port can be forwarded to the high frequency output port of the frequency extension device via the low frequency path. Alternatively, the radio frequency signal received via the single radio frequency input port can be processed by the high frequency path, e.g. multiplied in frequency, such that a processed radio frequency signal is forwarded to the high frequency output port for being outputted.

The combining circuit further ensures that both the multiplied radio frequency signal processed by the at least one high frequency path and the originally inputted radio frequency signal processed by the low frequency path may be combined before being forwarded to the high frequency output port. This ensures a high frequency range of the high frequency output signal, namely a high frequency range of the signal generator system. For instance, the originally inputted radio frequency signal is associated with a frequency range f1 to f2, whereas the processed radio frequency signal, namely the multiplied radio frequency signal, may be associated with a frequency range f2 to f3. The combining circuit may combine both signals to obtain a combined radio frequency signal having a frequency range f1 to f3. This frequency range is enlarged compared to the frequency range of the multiplied radio frequency signal, namely the radio frequency signal processed by the at least one high frequency path.

In case an excellent spectral purity is required, the switch located in the low frequency path may be activated in order to interrupt the contribution of the low frequency path to the combining circuit.

An aspect provides that the low frequency path and the at least one high frequency path, for example, both originate from the signal distribution circuit and both end at the combining circuit. The low frequency path and the at least one high frequency path are parallel to each other. Therefore, the radio frequency signal inputted to the single radio frequency input port of the frequency extension device can be distributed by the signal distribution circuit accordingly such that the same radio frequency signal is processed by the low frequency path solely, the at least one high frequency path solely or by both paths simultaneously. Irrespective of the distribution of the radio frequency signal, the combining circuit ensures that the radio frequency signal(s) processed are/is outputted, for instance in a combined manner. The paths are parallel between the signal distribution circuit and the combining circuit. The respective paths both start at the signal distribution circuit and end at the combining circuit accordingly.

Another aspect provides that the combining circuit, for example, is configured to combine a low frequency signal forwarded via the low frequency path and a high frequency signal forwarded via the at least one high frequency path, thereby obtaining a combined signal that is forwarded to the at least one high frequency output port of the frequency extension device. The combined signal has an increased frequency range, as it combines the frequency ranges of the initially inputted radio frequency signal, e.g. f1 to f2, as well as the processed radio frequency signal, namely the multiplied radio frequency signal that has been processed by the high frequency path, e.g. f2 to f3. The increased frequency range of the combined signal may relate to f1 to f3 accordingly.

A further aspect provides that the switch located in the low frequency path is, for example, an isolator switch. This specific kind of switch ensures that the low frequency path can be isolated from the high frequency output port of the frequency extension device in a galvanic manner. Consequently, the initially inputted radio frequency signal is not (directly) forwarded to the high frequency output port via the low frequency path due to the isolator switch located in the low frequency path in case the isolator switch is activated, namely interrupts the electrical connection established by the low frequency path.

In an embodiment, the switch may have an open switching state in which signal forwarding via the low frequency path is interrupted and a closed switching state in which a signal forwarding via the low frequency path is permitted. The respective switching state of the switch ensures whether the frequency range of the generated high frequency output signal is increased or not, as the additional frequency range of the initially inputted radio frequency signal is added or not, which depends on the switching state of the switch. Similar, the spectral purity can be adapted by interrupting any contribution of the low frequency path to the high frequency output signal.

For instance, the switch is a single pole multiple throw (SPMT) switch or a shunt switch. The single pole of the SPMT switch is associated with the low frequency path, whereas one of the multiple throws is associated with the combining circuit. At least one other of the multiple throws is associated with anything different, e.g. a resistance or ground. Alternatively, a shunt switch is used, namely a switch connecting the low frequency path to a shunt in one switching state.

In an embodiment, the switch is located between the signal distribution circuit and the combining circuit. In other words, the switch is located in the low frequency path that originates from the signal distribution circuit and ends at the combining circuit.

Generally, the switch may be separately formed with respect to the signal distribution circuit and the combining circuit. Accordingly, the switch may be a separately formed component. In other words, the switch may be implemented on a separately formed chip compared to the signal distribution circuit and the combining circuit, e.g. isolated with respect to chip level. Therefore, a galvanic isolation can be ensured.

In an embodiment, the signal distribution circuit may separate the low frequency path and the at least one high frequency path from each other in a galvanic manner. Depending on the respective configuration of the signal distribution circuit, the signal distribution circuit may ensure that no electrical connection is established between the low frequency path and the at least one high frequency path via the signal distribution circuit.

For instance, the signal distribution circuit may comprise a coupling circuit, for instance a coupler, via which the low frequency path and the at least one high frequency path both are connected to the single radio frequency input port of the frequency extension device. Therefore, the coupling circuit, for example the coupler, may ensure that no electrical line/connection is established between the paths via the signal distribution circuit. The coupling circuit however ensures that the radio frequency signal inputted via the single radio frequency input port is distributed to both paths simultaneously, namely the low frequency path and the at least one high frequency path. Hence. the increased frequency range of the high frequency output signal can be obtained. In case ideal spectral purity is intended, the switch located in the low frequency path is activated in order to suppress any contribution of the originally inputted radio frequency signal.

According to another embodiment, the signal distribution circuit comprises a switching circuit, for instance a switch, which has a first switching position in which the input port of the frequency extension device is connected to the at least one high frequency path and a second switching position in which the input port of the frequency extension device is connected to the low frequency path. The switching circuit may comprise a third switching position in which the input port of the frequency extension device is connected to both, the at least one high frequency path and the low frequency path. Depending on the switching circuit, the low frequency path may be isolated from the input port of the frequency extension device in the first switching position and the at least one high frequency path may be isolated from the input port of the frequency extension device in the second switching position.

Accordingly, the switching circuit ensures isolation of the paths from the radio frequency input port depending on the respective switching position of the switching circuit. In general, the switching circuit ensures that the radio frequency signal inputted via the single radio frequency input port is forwarded to the high frequency path and/or the low frequency path, which depends on the switching position of the switching circuit. Therefore, the switching circuit ensures signal distribution within the frequency extension device.

A further aspect provides that the base device and the frequency extension device, for example, are separately formed devices which are connected with each other by a single radio frequency line. In other words, exactly one radio frequency line is used for connecting the base device and the frequency extension device. The frequency extension device has only one single radio frequency input port such that only one single radio frequency line can be used for connecting the frequency extension device to the base device. Even though the single radio frequency line is used, the signal generator system nevertheless ensures generating high frequency output signals with large frequency ranges due to the fact that the radio frequency signal inputted via the single radio frequency input port is internally processed via the different paths. The combining circuit ensures that the frequency ranges of the radio frequency signals processed by the two different internal paths can be combined, thereby obtaining the increased frequency range of the high frequency output signal.

In an embodiment, the at least one high frequency output port of the frequency extension device may be a coaxial output port or a waveguide output port. Thus, the high frequency output signal generated may be outputted via a coaxial output port or via a waveguide output port. Depending on the application scenario of the signal generator system, a coaxial output port or a waveguide output port may be more appropriate for the signal generator system.

In an embodiment, the combining circuit may comprise a switch, a mixer and/or a coupler, for instance a forward coupler. These components ensure that the radio frequency signals processed by the different paths can be combined in an intended manner to obtain the combined radio frequency signal that is forwarded to the high frequency output port, namely the high frequency output signal.

In an embodiment, the at least one amplifier and/or at least one frequency multiplier may be located in the at least one high frequency path. The at least one amplifier ensures amplification of the amplitude of the radio frequency processed by the at least one high frequency path. The at least one frequency multiplier ensures multiplication of the frequency of the radio frequency processed by the at least one high frequency path.

In an embodiment, the base device may comprise a control interface and/or a power supply interface. The respective interfaces may be used for forwarding data and/or signals from the base device to the frequency extension device.

In an embodiment, the base device may be connected with the frequency extension device via the control interface and/or the power supply interface in order to forward a control signal for controlling frequency output range of the frequency extension device and/or a power supply to the frequency extension device. Therefore, controlling of the frequency extension device may be ensured by the separately formed base device that forwards the control signals to the frequency extension device. The control signals may be internally processed by the frequency extension device in order to control the amplifier and/or the frequency multiplier appropriately. In addition, the switch located in the low frequency path may be controlled via the control signals. Furthermore, the signal distribution circuit may be controlled by the control signals as well.

In addition or alternatively, the power supply of the frequency extension device may be ensured, as power (signal) is forwarded to the frequency extension device.

According to a certain embodiment, the control interface and/or the power supply interface may be integrated a single interface. Hence, control signals and power supply may be ensured via a single interface. For instance, the control interface and/or the power supply interface may be implemented by the radio frequency output port of the base device.

A further aspect provides that the base device comprises, for example, an internal control circuit configured to control the control signal and/or the power supply signal to be forwarded to the frequency extension device via the control interface and/or the power supply interface. Therefore, controlling of the frequency extension device may be done by the base device at least indirectly. In other words, a control signal may be forwarded to the base device that processes the control signal for generating the control signal for the frequency extension device accordingly. This is controlled by the internal control circuit of the base device.

In an embodiment, the frequency extension device also has a receiving control circuit that processes the control signals received from the internal control circuit of the base device accordingly.

For instance, the control interface is a local area network (LAN) interface and/or wherein the power supply interface is a local area network (LAN) interface. Thus, the control signals as well as power supply may be forwarded via the respective LAN interface.

For instance, a Power-over-Ethernet (POE) interface is provided.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a signal generator system according to a an embodiment of the present disclosure, and

FIG. 2 schematically shows a signal generator system according to a another embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

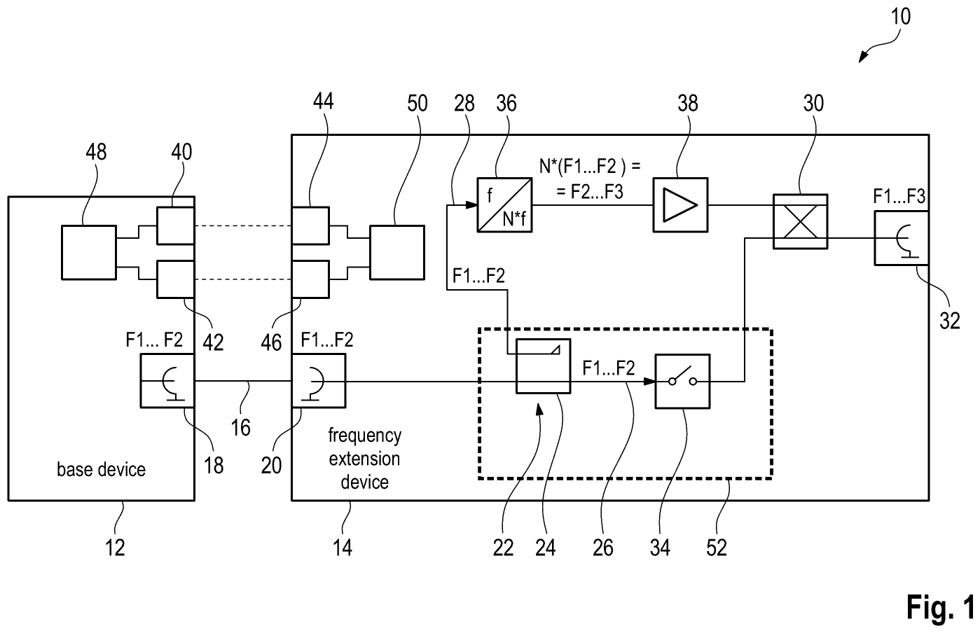

In FIG. 1, an embodiment of a signal generator system 10 is shown, which is suitable for generating a high frequency output signal. Generally described, the signal generator system 10 comprises a base device 12 and a frequency extension device 14 which are separately formed devices that are connected with each other by a single radio frequency line 16.

In the embodiment shown, the base device 12 has a radio frequency output port 18 via which a radio frequency signal is outputted that is forwarded via the radio frequency line 16 to the frequency extension device 14. The frequency extension device 14 has exactly one radio frequency input port 20 via which the radio frequency signal from the base device 12 is received.

As shown in FIG. 1, the base device 12 as well as the frequency extension device 14 both comprise exactly one radio frequency port via which the radio frequency connection is established, namely the radio frequency output port 18 and the radio frequency input port 20, respectively. As further illustrated in FIG. 1, the radio frequency signal is associated with a frequency range from F1 to F2.

The frequency extension device 14 further comprises a signal distribution circuit 22 that is connected to the single radio frequency input port 20. The signal distribution circuit 22 is configured to internally distribute the radio frequency signal received via the single radio frequency input port 20. In the shown embodiment, the signal distribution circuit 22 comprises a coupling circuit 24, for instance a coupler.

In an embodiment, the frequency extension device 14 further comprises a low frequency path 26 as well as a high frequency path 28 that both originate from the signal distribution circuit 22. In other words, the signal distribution circuit 22 is connected with the radio frequency input port 20 located upstream of the signal distribution circuit 22 and the low frequency path 26 as well as the at least one high frequency path 28 which both are located downstream of the signal distribution circuit 22.

In the embodiment of FIG. 1, the low frequency path 26 as well as the at least one high frequency path 28 both end at a combining circuit 30 of the frequency extension device 14. The combining circuit 30 is further connected with at least one high frequency output port 32 of the frequency extension device 14. The at least one high frequency output port 32 may be a coaxial output port or a waveguide output port. This depends on the specific application scenario, namely which component is connected to the high frequency output port 32.

As shown in FIG. 1, the at least one high frequency output port 32 is located downstream of the combining circuit 30, whereas the low frequency path 26 and the at least one high frequency path 28 both are located upstream of the combining circuit 30.

Hence, the low frequency path 26 and the at least one high frequency path 28 are in parallel to each other, wherein both paths 26, 28 originate from the signal distribution circuit 22 and wherein both paths 26, 28 end at the combining circuit 30.

In the low frequency path 26, a switch 34 is provided, for example, that relates to an isolator switch. In an embodiment, the switch 34 has two switching states, namely an open switching state in which signal forwarding via the low frequency path 26 is interrupted (as shown in FIG. 1) as well as a closed switching state in which signal forwarding via the low frequency path 26 is permitted. Generally, the switch 34 may be implemented as a single pole multiple throw switch or a shunt switch.

In order to ensure isolation, the switch 34 is separately formed with respect to the signal distribution circuit 22 and the combining circuit 30.

The radio frequency signal inputted via the single radio frequency input port 20 of the frequency extension device 14 can be forwarded via the signal distribution circuit 22 and the low frequency path 26 with the switch 34 in its closed switching state to the combining circuit 30. As shown in FIG. 1, the radio frequency signal forwarded via the low frequency path 26 still has the frequency range F1 to F2.

In addition or alternatively, the radio frequency signal inputted via the single radio frequency input port 20 of the frequency extension device 14 can be forwarded via the signal distribution circuit 22 and the at least one high frequency path 28 to the combining circuit 30.

In an embodiment, the at least one high frequency path 28 comprises a frequency multiplier 36 that is used to multiply the frequency. As illustrated in FIG. 1, the frequency of the originally inputted radio frequency signal is multiplied from F1 to F2 to F2 to F3. In addition, the at least one high frequency path 28 comprises an amplifier 38 that is used to amplify the amplitude of the multiplied signal.

Therefore, a processed radio frequency signal is obtained by the at least one high frequency path 28, which is forwarded to the combining circuit 30. The radio frequency signal processed by the at least one high frequency path 28 is multiplied with regard to its frequency and amplified with regard to its amplitude accordingly.

In general, the radio frequency signal inputted via the single radio frequency input port 20 may be forwarded to the low frequency path 26 and/or the at least one high frequency path 28. This depends, for example, on the specific configuration of the signal distribution circuit 22 and/or the state of the signal distribution circuit 22.

The radio frequency signal distributed to the low frequency path 26 is forwarded to the combing circuit 30 provided that the switch 34 located in the low frequency path is in its closed switching state in which signal forwarding via the low frequency path 26 is permitted. The radio frequency signal processed by the low frequency path 26 is associated with a frequency range of F1 to F2.

The radio frequency signal distributed to the at least one high frequency path 28 is multiplied by the frequency multiplier 36 and amplified by the amplifier 38. The radio frequency signal processed by the high frequency path 28, e.g. the multiplied and amplified radio frequency signal, is forwarded to the combing circuit 30 as well. The radio frequency signal processed by the high frequency path 28 is associated with a frequency range of F2 to F3.

The combining circuit 30 combines both radio frequency signals received, namely the initially inputted radio frequency signal that is received from the low frequency path 26 as well as the processed radio frequency signal received from the at least on high frequency path 28. Hence, a combined radio frequency signal is obtained that has an increased frequency range compared to the initially inputted radio frequency signal and the processed radio frequency signal. In the shown embodiment, the combined radio frequency signal is associated with a frequency range from F1 to F3 as shown in FIG. 1.

In an embodiment, the combining circuit 30 may comprise a switch, a mixer and/or a coupler, for instance a forward coupler, in order to combine the radio frequency signals received from both paths 26, 28.

In case the signal distribution circuit 22 comprises the coupling structure 24 as shown in FIG. 1, the radio frequency signal inputted via the single radio frequency input port 20 may always be forwarded to both paths 26, 28, namely irrespective of any state of the signal distribution circuit 22.

The contribution of the low frequency path 26 may however be suppressed or interrupted by the switch 34 located in the low frequency path 26. In an embodiment, the originally inputted radio frequency signal is not forwarded to the combining circuit 30 in case the switch 34 is switched to an open switching state in which signal forwarding via the low frequency path 26 is interrupted. This improves the spectral purity of the high frequency output signal while reducing the frequency range of the high frequency output signal.

In an embodiment, the base device 12 comprises a control interface 40 and/or a power supply interface 42. Both interfaces 40, 42 relate to output interfaces. In an alternative embodiment, the control interface 40 and the power supply interface 42 may be established by a single interface. Furthermore, the control interface 40 and/or the power supply interface 42 may be implemented by the radio frequency output port 18.

In an embodiment, the frequency extension device 14 may also have a control interface 44 as well as a power supply interface 46 which however relate to input interfaces.

In other words, in an embodiment, the base device 12 and the frequency extension device 14 may be connected with each other via the respective interfaces, mainly the control interfaces 40, 44 and/or the power supply interfaces 42, 46 as well. By these interfaces 42 46, no radio frequency signals are exchanged, but data or power supply solely. The respective interfaces 40 to 46 may be implemented as local area network (LAN) interfaces.

In an embodiment, the base device 12 comprises an internal control circuit 48 configured to control the control signal and/or the power supply signal to be forwarded to the frequency extension device 14 via the control interface 40 and/or the power supply interface 42. In an embodiment, the frequency extension device 14 also has a receiving control circuit 50 that processes the control signals received from the internal control circuit 48 of the base device 12 accordingly, namely via the interfaces 40 to 46.

Generally, the signal distribution circuit 22 and the switch 34 together establish an isolating signal processing circuit 52, which ensures that the radio frequency signal inputted is multiplied with regard to frequency in order to generate a high frequency output signal with ideal spectrum purity or that the radio frequency signal inputted is multiplied with regard to frequency in order to generate a high frequency output signal with increased frequency range. This depends, for example, on the state(s) of the signal distribution circuit 22 and the switch 34 accordingly, as discussed above.

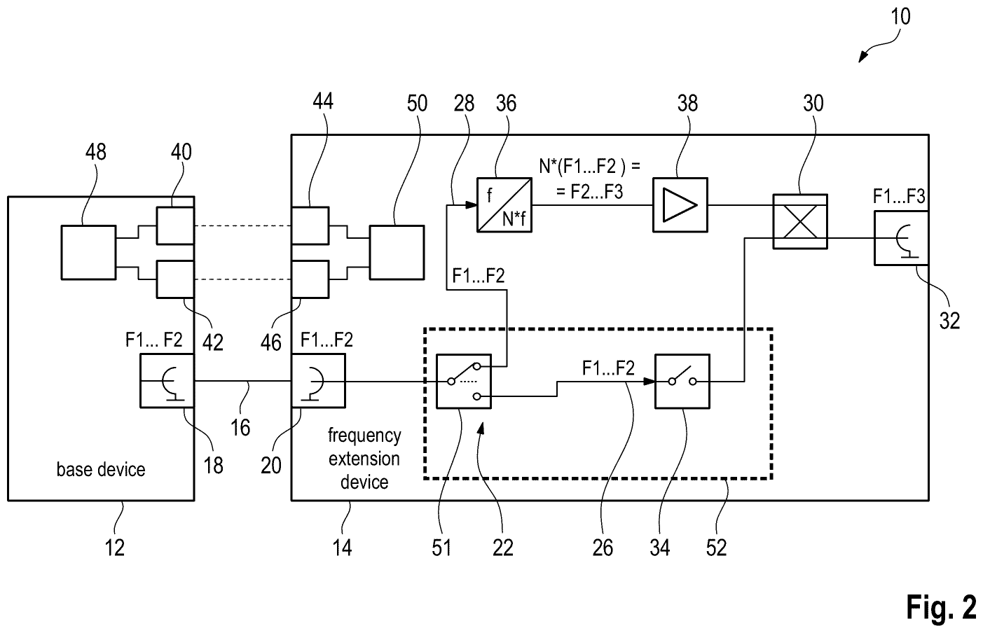

In FIG. 2, a second embodiment of the signal generator system 10 is shown. The second embodiment distinguishes from the first embodiment in that the signal distribution circuit 22 comprises a switching circuit 48 instead of the coupling circuit 24 shown in FIG. 1.

In an embodiment, the switching circuit 48 has at least a first switching position in which the input port 20 of the frequency extension device 14 is connected to the at least one high frequency path 28 as well as a second switching position in which the radio frequency input port 20 of the frequency extension device 14 is connected to the low frequency path 26.

In an embodiment, a third switching position may be provided in which both, the low frequency path 26 and the at least one high frequency path 28, are connected via the switching circuit 48 to the input port 20 such that the radio frequency signal inputted is processed by both paths 26, 28 simultaneously, thereby ensuring the large frequency range from F1 to F3.

Despite the specific implementation of the signal distribution circuit 22, both embodiments have the same functionality such that reference is made to the explanations given above.

In an embodiment, the signal distribution circuit 22 may however separate the low frequency path 26 and the at least one high frequency path 28 from each other in a galvanic manner. As discussed above, the galvanic isolation is further ensured by the switch 34 that is formed separately with respect to the signal distribution circuit 22 and the combining circuit 30, e.g. on a separate chip or as a separate device.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc.

In an embodiments, one or more of the components of the base device 12 and/or the frequency extension device 14 include circuitry programmed to carry out one or more functions, processing steps, etc., disclosed herein. In an embodiments, one or more computer-readable media associated with or accessible by such circuitry contains computer readable instructions embodied thereon that, when executed by such circuitry, cause the component or circuity to perform one or more functions, processing steps, etc., disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible to a computing device, such as processor circuitry, etc., or other circuity disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In some embodiments, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods or processes described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A signal generator system for generating a high frequency output signal, the signal generator system comprising:
a base device, wherein the base device comprises a radio frequency output port via which a radio frequency signal is outputted;
a frequency extension device, wherein the frequency extension device comprises:
exactly one radio frequency input port that is connected with the radio frequency output port of the base device;
at least one high frequency output port, a low frequency path and at least one high frequency path;
a signal distribution circuit that is connected to the radio frequency input port of the frequency extension device, the low frequency path and the at least one high frequency path;
a switch located in the low frequency path; and
a combining circuit connected with the low frequency path, the at least one high frequency path and the at least one high frequency output port of the frequency extension device.

2. The signal generator system according to claim 1, wherein the low frequency path and the at least one high frequency path both originate from the signal distribution circuit and both end at the combining circuit, and wherein the low frequency path and the at least one high frequency path are parallel to each other.

3. The signal generator system according to claim 1, wherein the combining circuit is configured to combine a low frequency signal forwarded via the low frequency path and a high frequency signal forwarded via the at least one high frequency path, thereby obtaining a combined signal that is forwarded to the at least one high frequency output port of the frequency extension device.

4. The signal generator system according to claim 1, wherein the switch located in the low frequency path is an isolator switch.

5. The signal generator system according to claim 1, wherein the switch has an open switching state in which signal forwarding via the low frequency path is interrupted and a closed switching state in which signal forwarding via the low frequency path is permitted.

6. The signal generator system according to claim 1, wherein the switch is a single pole multiple throw switch or a shunt switch.

7. The signal generator system according to claim 1, wherein the switch is located between the signal distribution circuit and the combining circuit.

8. The signal generator system according to claim 1, wherein the switch is separately formed with respect to the signal distribution circuit and the combining circuit.

9. The signal generator system according to claim 1, wherein the signal distribution circuit separates the low frequency path and the at least one high frequency path from each other in a galvanic manner.

10. The signal generator system according to claim 1, wherein the signal distribution circuit comprises a coupling circuit via which the low frequency path and the at least one high frequency path both are connected to the radio frequency input port of the frequency extension device.

11. The signal generator system according to claim 1, wherein the signal distribution circuit comprises a switching circuit having a first switching position in which the input port of the frequency extension device is connected to the at least one high frequency path and a second switching position in which the input port of the frequency extension device is connected to the low frequency path.

12. The signal generator system according to claim 1, wherein the base device and the frequency extension device are separately formed devices which are connected with each other by a single radio frequency line.

13. The signal generator system according to claim 1, wherein the at least one high frequency output port of the frequency extension device is a coaxial output port or a waveguide output port.

14. The signal generator system according to claim 1, wherein the combining circuit comprises a switch, a mixer and/or a coupler, for instance a forward coupler.

15. The signal generator system according to claim 1, wherein at least one of an amplifier and a frequency multiplier is located in the at least one high frequency path.

16. The signal generator system according to claim 1, wherein the base device comprises a control interface and/or a power supply interface.

17. The signal generator system according to claim 16, wherein the base device is connected with the frequency extension device via the control interface and/or the power supply interface in order to forward a control signal for controlling frequency output range of the frequency extension device and/or a power supply to the frequency extension device.

18. The signal generator system according to claim 17, wherein the base device comprises an internal control circuit configured to control the control signal and/or the power supply to be forwarded to the frequency extension device via the control interface and/or the power supply interface.

19. The signal generator system according to claim 16, wherein the control interface is a Local Area Network interface and/or wherein the power supply interface is a Local Area Network interface.
